(19) United States
(12) Patent Application Publication
(10) Pub. No.: US 2024/0353762 A1
(43) Pub. Date: Oct. 24, 2024

(54) SIMULATION APPARATUS, SIMULATION METHOD, PROGRAM RECORDING MEDIUM, AND METHOD OF MANUFACTURING ARTICLE

(71) Applicant: CANON KABUSHIKI KAISHA, Tokyo (JP)

(72) Inventors: HIROMU KIJIMA, Tochigi (JP); HIROKI ECHIGO, Tochigi (JP); MASAYOSHI FUJIMOTO, Tochigi (JP)

(21) Appl. No.: 18/609,202

(22) Filed: Mar. 19, 2024

(30) Foreign Application Priority Data
Apr. 21, 2023 (JP) 2023-069979

(51) Int. Cl. G03F 7/00

(52) U.S. Cl. CPC G03F 7/7065; G03F 7/705

(57) ABSTRACT

Provided is a simulation apparatus configured to, in a process of bringing a member into contact with a plurality of droplets placed on a substrate to form a film of a curable composition on the substrate, highly accurately and rapidly predict spread of boundary droplets located in a boundary region which is a region on the substrate corresponding to at least an edge of the member when the member is contacted. The simulation apparatus includes an acquisition unit configured to acquire information indicating placement of the plurality of droplets on the substrate and a first droplet region which is a predicted region in which each of the droplets spreads around the droplet, and a prediction unit configured to predict, as a second droplet region, a region in which each of the boundary droplets spreads around the boundary droplet in a different way from the first droplet region of droplets other than the boundary droplet in the first droplet region acquired by the acquisition unit.

### BACKGROUND OF THE INVENTION

### Field of the Invention

The present invention relates to a simulation apparatus, a simulation method, a program recording medium, and a method of manufacturing an article.

### Description of the Related Art

### DESCRIPTION OF THE RELATED ART

There is an imprint technique of forming a fine pattern by bringing a mold on which a fine pattern (concavo-convex pattern) is formed (transferred) in contact with an imprint material (for example, a photo-curable resin) supplied onto a substrate. This imprint technique is attracting attention as a nanolithography technique for mass production of semiconductor devices and magnetic storage media. One of these imprint techniques is a photo-curing method of using a photo-curable resin as an imprint material. In an imprint apparatus that adopts this photo-curing method, an imprint material is first supplied (coated) onto a substrate. Next, a pattern is formed on the substrate by curing the imprint material through irradiation with light such as ultraviolet rays in a state where the patterned mold is brought into contact with the imprint material, and then releasing the mold from the cured imprint material.

In addition, in an imprint apparatus, when a resin is supplied onto a substrate, an array of droplets (drops) of an imprint material is formed on the substrate using, for example, an inkjet method. Then, by bringing the droplets of the imprint material on the substrate into contact with a mold, such an imprint material fills (infiltrates) the concave portions of the pattern of the mold. However, in the imprint apparatus, defects may occur in the pattern formed on the substrate due to differences in the pattern of the mold, manufacturing variations, or the like, which makes it difficult to consistently form a high-quality pattern. In order to avoid such a problem, it is necessary to adjust a drop recipe (imprint recipe) which is coating information (a coating pattern) indicating the supply position of resin droplets on the substrate.

The coating pattern is corrected until there are no more defects in the pattern formed on the substrate through an imprint process. In order to perform this correction, it is necessary to repeat the imprint process and correction of the drop recipe, which takes a long time.

To address such a problem, Patent Literature 1 proposes a method of simultaneously displaying a drop recipe and inspection information or analysis information to support correction of the drop recipe. Patent Literature 2 proposes a method of simulating the spread shape of a drop using calculation of fluid flow.

Patent Literature 1 describes that the degree of spread of a droplet is shown using a Voronoi diagram. However, although the Voronoi diagram is mainly effective in predicting the spread shape of drops located inside a shot region (inside a shot), the spread shape of drops may be incorrectly predicted in the periphery of the shot region on a substrate (in the periphery of the shot). In addition, the simulation accompanied by the calculation of fluid flow disclosed in Patent Literature 2 makes it possible to predict the correct spread shape even in the periphery of the shot, but this requires a large number of calculation resources.

### SUMMARY OF THE INVENTION

An exemplary object of the present invention is to make it possible to predict the spread shape of drops placed in the periphery of a shot region on a substrate with a high degree of accuracy and at high speed.

According to an aspect of the present invention, there is provided a simulation apparatus configured to, in a process of bringing a member into contact with a plurality of droplets placed on a substrate to form a film of a curable composition on the substrate, predict spread of boundary droplets located in a boundary region which is a region on the substrate corresponding to at least an edge of the member when the member is contacted, the simulation apparatus including: an acquisition unit configured to acquire information indicating placement of the plurality of droplets on the substrate and a first droplet region which is a predicted region in which each of the droplets spreads around the droplet; and a prediction unit configured to predict, as a second droplet region, a region in which each of the boundary droplets spreads around the boundary droplet in a different way from the first droplet region of droplets other than the boundary droplet in the first droplet region acquired by the acquisition unit.

Further features of the present invention will become apparent from the following description of exemplary embodiments with reference to the attached drawings.

### BRIEF DESCRIPTION OF THE DRAWINGS

FIG. 1 is a schematic diagram illustrating a configuration of an imprint apparatus of an embodiment.

FIG. 2 is a diagram illustrating a configuration example of a simulation apparatus in the embodiment.

FIG. 3 is a diagram illustrating a configuration example of hardware in which the simulation apparatus of the embodiment is implemented.

FIG. 4 is a diagram illustrating an example of coating information of an imprint material.

FIG. 5 is a diagram illustrating supply of the imprint material onto a substrate.

FIG. 6 is a diagram illustrating an example of an operation screen of an editor that functions as a user interface.

FIG. 7 is a configuration diagram illustrating a configuration example of a simulator according to Example 1.

FIG. 8 is a flowchart illustrating an example of a simulation process for the spread of drops in the periphery of a shot in Example 1.

FIG. 9 is a flowchart illustrating an example of a classification process for drops in step S12 of FIG. 8.

FIG. 10 is a diagram illustrating an example of a Voronoi diagram acquired in step S121.

FIG. 11 is a diagram illustrating the process of step S122.

FIG. 12 is a diagram illustrating the process of step S123.

FIG. 13 is a diagram illustrating an example of a classification process for drops.

FIG. 14 is a diagram illustrating a first example in which the spread shape of drops in the periphery of the shot is predicted using a method different from the Voronoi diagram.

FIG. 15 is a diagram illustrating a second example in which the spread shape of drops in the periphery of the shot is predicted using a method different from the Voronoi diagram.

FIG. 16 is a diagram illustrating a third example in which the spread shape of drops in the periphery of the shot is predicted using a method different from the Voronoi diagram.

FIG. 17 is a flowchart illustrating an example of a process of adjusting drops according to Example 2.

FIG. 18 is a diagram illustrating the positions of drops that can be placed by a dispenser.

FIG. 19 is a diagram illustrating an example in which the spread shape of drops in the periphery of the shot according to Example 2 is predicted.

FIG. 20 is a diagram illustrating an example of analysis information on extrusion.

FIG. 21 is a diagram illustrating an example of analysis information on nonfill NF.

FIG. 22 is a diagram illustrating an example of a process of associating drops with extrusion in step S4.

FIG. 23 is a diagram illustrating an example of a process of associating drops with nonfill in step S4.

FIG. 24 is a diagram illustrating an example in which a defect straddles the spread shape of a plurality of drops.

FIG. 25 is a diagram illustrating an example in which a defect straddles the spread shape of a plurality of drops.

FIG. 26 is a diagram illustrating an example in which different types of defects exist in the spread shape of the same drop.

FIG. 27 is a diagram illustrating an example in which the amount of movement of drops is changed in accordance with the size of a defect.

FIG. 28 is a diagram illustrating an example in which the amount of movement of drops is changed in accordance with the size of a defect.

FIG. 29 is a diagram illustrating processing in a case where another defect occurs after the adjustment of drops.

FIGS. 30A to 30F are diagrams illustrating a method of manufacturing an article.

### DESCRIPTION OF THE EMBODIMENTS

Hereinafter, preferable embodiments of the present invention will be described in detail with reference to the accompanying drawings.

### EMBODIMENT

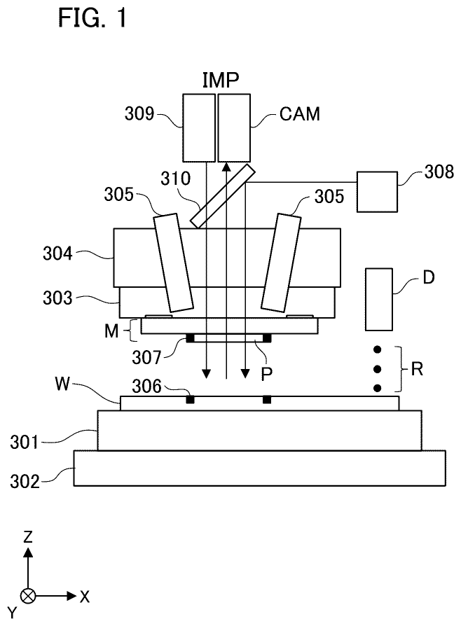

FIG. 1 is a schematic diagram illustrating a configuration of an imprint apparatus IMP of the present embodiment. The imprint apparatus IMP is a lithography apparatus that forms a pattern of an imprint material on a substrate using a mold (mask) M. The imprint apparatus IMP is configured to form a pattern in a plurality of shot regions (pattern formation regions, imprint regions) of a substrate W by repeating an imprint process. Here, the imprint process is a series of cycles including supplying an imprint material R to the substrate W, contacting the mold M with the imprint material R, filling the pattern of the mold M with the imprint material R, positioning (alignment), curing (exposure), and peeling off the mold M. Meanwhile, in the present embodiment, the term “shot region” refers to a region having a size equivalent to one pattern P of the mold M, that is, a region where a pattern of an imprint material corresponding to the pattern of the mold M is formed in a single imprint process (formation region).

A curable composition (sometimes referred to as an uncured resin) which is cured by being given energy for curing is used for the imprint material R. Electromagnetic waves, heat, or the like is used for the energy for curing. As the electromagnetic waves, for example, light such as infrared rays, visible rays of light, or ultraviolet rays of which the wavelength is selected from a range between 10 nm and 1 mm is used. That is, the imprint material R may be an ultraviolet curable resin which is cured by irradiation with ultraviolet rays, or the imprint material R may be a thermoplastic or thermosetting resin.

The curable composition is a composition which is cured by irradiation with light or by heating. A photo-curable composition which is cured by irradiation with light contains at least a polymerizable compound and a photopolymerization initiator, and may contain a non-polymerizable compound or a solvent as necessary. The non-polymerizable compound is at least one selected from the group of sensitizers, hydrogen donors, internal mold release agents, surfactants, antioxidants, polymer components, and the like.

The substrate W may be made of glass, ceramics, metals, semiconductors, resins, or the like, and a member made of a material different from the substrate may be formed on its surface as necessary. Specifically, examples of the substrate include a silicon wafer, a compound semiconductor wafer, quartz glass, and the like.

The imprint apparatus IMP of the present embodiment includes a substrate chuck 301 (substrate holding portion) that holds the substrate W, a substrate stage 302, a mold chuck 303 (mold holding portion), and a mold stage 304 (mold driving portion). Further, it may also include a dispenser D (supply portion), an alignment scope 305, a light source 308, a detection light source 309, and a mirror 310.

The substrate chuck 301 holds the substrate W. The substrate chuck 301 holds the substrate W using, for example, a vacuum suction pad or the like. The substrate stage 302 holds the substrate chuck 301 and is driven by a drive mechanism (not shown) to move the substrate W along six axes, thereby aligning the substrate W and the mold M. The drive mechanism may be constituted by a plurality of drive mechanisms such as a coarse drive mechanism and a fine drive mechanism. The substrate W is a substrate onto which a concavo-convex pattern is transferred, and includes, for example, a single crystal silicon substrate, a silicon on insulator (SOI) substrate, or the like.

The mold chuck 303 holds the mold M on which the pattern (pattern portion) P is formed. The mold M is held by the mold chuck 303 using, for example, vacuum suction force, electrostatic force, or the like. The mold stage 304 holds the mold chuck 303 and drives the mold chuck 303 using a drive mechanism (not shown). The mold M has, for example, a rectangular outer circumferential portion, has a predetermined concavo-convex pattern formed in a three-dimensional shape on a surface facing the substrate W, and is made of a material that transmits ultraviolet rays (such as quartz).

The dispenser D may have, for example, a tank that accommodates the imprint material R, a nozzle N that discharges the imprint material R supplied from the tank through a supply channel to the substrate W, a valve provided in the supply channel, and a supply amount control unit. The supply amount control unit controls the amount of the imprint material supplied to the substrate W, for example, by controlling a valve so that the imprint material R is applied to one shot region in a single operation of discharge of the imprint material R.

The alignment scope 305 is fixed to the mold stage 304 and detects an alignment mark formed on the substrate W (a substrate-side mark 306) and an alignment mark formed on the mold M (a mold-side mark 307). The substrate-side mark 306 is formed in a shot region on the substrate W, and the mold-side mark 307 is formed on the pattern P of the mold M. A calculation section 221 in a control unit 220 which will be described later obtains the relative positional deviation between the mold M and the substrate W from the detection results of the substrate-side mark 306 and the mold-side mark 307 detected by the alignment scope 305. The control unit 220 drives the substrate stage 302 and the mold stage 304 on the basis of the result of the obtained relative positional deviation, and corrects the relative positional deviation between the mold M and the substrate W. The relative positional deviation is not limited to shift components, and also includes errors in magnification and rotation components. The shape of the pattern P of the mold M can be corrected in accordance with the shot region formed on the substrate W. As a method of detecting the substrate-side mark 306 and the mold-side mark 307, an interference signal such as a moire signal in which the relative position of these two marks is reflected can be used. In addition, the relative position of the two marks may be obtained by detecting the image of each mark.

The light source 308 is a light source that emits (radiates) exposure light (ultraviolet rays), and the detection light source 309 is a light source for detection that emits detection light. The mirror 310 is a dichroic mirror and has a characteristic of reflecting exposure light and transmitting detection light. The exposure light from the light source 308 is reflected by the mirror 310 and radiated onto the imprint material R to cure the imprint material R. Thereby, the pattern P of the mold M is formed on (transferred onto) the substrate W.

The detection light from the detection light source 309 passes through the mirror 310, the mold stage 304, and the mold chuck 303, and illuminates the shot region on the substrate W. The light that illuminates the shot region is reflected by the surface of the substrate W and the patterned surface of the mold M, and the reflected light from the substrate W and the reflected light from the mold M are detected by an image capturing unit CAM as detection light. The detection light detected by the image capturing unit CAM is displayed on a monitor 201 so that an operator can observe the state of the imprint process. That is, the image capturing unit CAM can acquire a spread image of the imprint material R when the mold M is contacted, and the image capturing unit CAM has a function as an image acquisition unit. In addition, the image obtained by the image capturing unit CAM can be treated as inspection information.

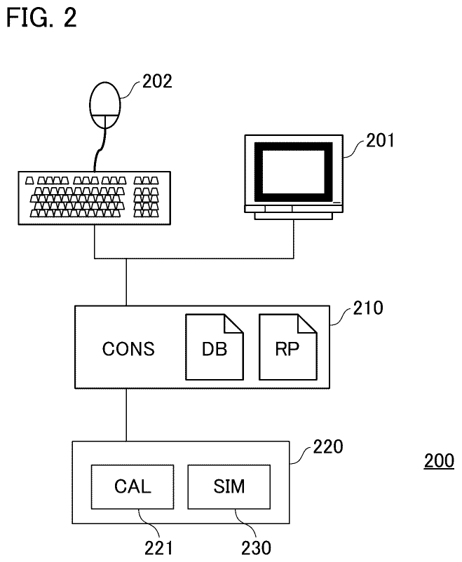

FIG. 2 is a diagram illustrating a configuration example of a simulation apparatus 200 in the present embodiment. The simulation apparatus 200 may include a console unit 210, the control unit 220, the monitor 201, and an input device 202.

The console unit 210 generates and manages an operation screen (edit screen) such as, for example, a drop adjustment editor 600 that functions as a user interface. In addition, the console unit 210 manages, for example, a database DB and a drop recipe which is coating information RP of the imprint material R, and causes the monitor 201 to display the drop recipe. That is, the console unit 210 has a function as a display control unit. The monitor 201 is a display apparatus that displays an operation screen and also functions as a display unit. The input device 202 is, for example, a keyboard or a mouse.

The control unit 220 controls the operations of the components of the imprint apparatus IMP in FIG. 1, for example, the substrate stage 302, the mold stage 304, and the dispenser D. The control unit 220 can be connected to each component of the imprint apparatus IMP through a line (wired or wireless). The method according to the present embodiment is executed by a computer as a program. In addition, the control unit 220 includes the calculation section 221 and a simulator 230.

The calculation section 221 obtains, for example, the relative positional deviation between the mold M and the substrate W from the detection results of the substrate-side mark 306 and the mold-side mark 307 detected by the alignment scope 305.

In the imprint process, the simulator 230 predicts the spread of the imprint material R when the mold M is contacted, and adjusts (changes) the drop recipe as necessary. The details of the configuration of the simulator 230 will be described later.

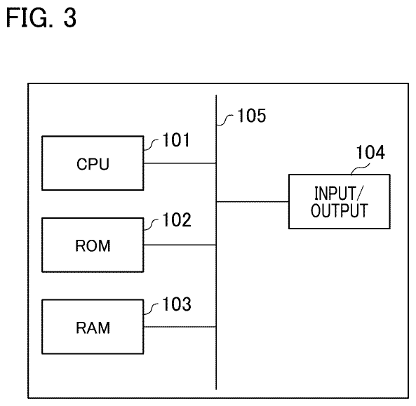

FIG. 3 is a diagram illustrating a configuration example of hardware in which the simulation apparatus 200 of the present embodiment is implemented. For example, in the imprint process, the simulation apparatus 200 is a computer that predicts and simulates the spread of the imprint material R when the mold M is contacted on the basis of the drop recipe, and displays the adjusted drop recipe as necessary. The simulation apparatus 200 includes a CPU 101, a ROM 102, a RAM 103, and an input/output 104 to and from an external storage device or the like which are connected to each other through a bus 105.

The CPU 101 operates on the basis of a program stored in the ROM 102 or the like, and controls each unit of the simulation apparatus 200. The ROM 102 stores a boot program executed by the CPU 101 when the simulation apparatus 200 is started up, programs depending on the hardware of the simulation apparatus 200, and the like. The CPU 101 realizes a flow to be described later, for example, by executing a program loaded onto the RAM 103. Meanwhile, the CPU 101 may acquire and execute these programs from another apparatus, for example, through a network.

The input/output 104 inputs an input signal from an external apparatus (such as an image pickup apparatus or an operation apparatus) in a format that can be processed by the simulation apparatus 200, and outputs an output signal to an external apparatus (such as a display apparatus) in a format that can be processed.

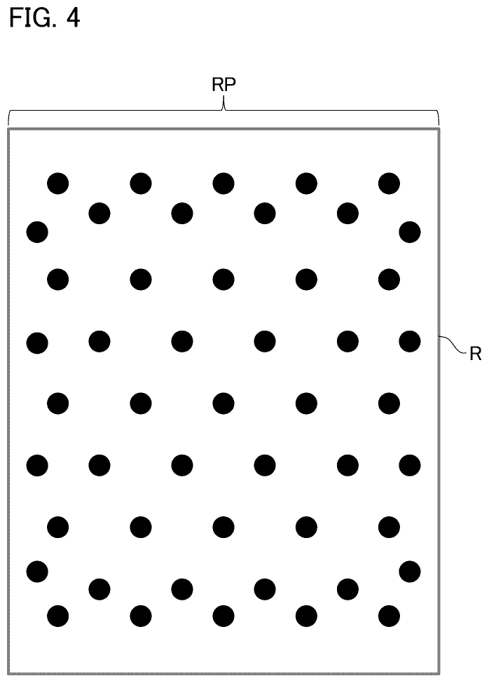

FIG. 4 is a diagram illustrating an example of the coating information RP of the imprint material R. The coating information RP is managed by the console unit 210, and the coordinates and amount indicating the position when the imprint material R is supplied to the substrate W are set (recorded) as a drop recipe. The control unit 220 controls the substrate stage 302 and the dispenser D so that the imprint material R is supplied to the position set in the coating information RP on the substrate W.

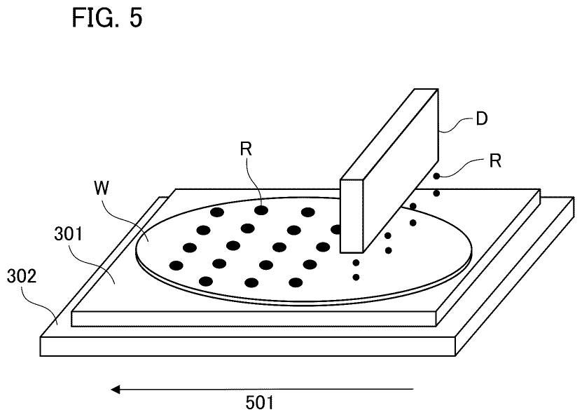

FIG. 5 is a diagram illustrating supply of the imprint material onto the substrate. Specifically, this drawing is a diagram illustrating a state in which the imprint material R is supplied (coated) onto the substrate W on the basis of the coordinate information of the coating information RP shown in FIG. 4. The control unit 220 controls the substrate stage 302 to move the substrate stage 302, for example, in the direction of an arrow 501. Droplets of the imprint material R are then supplied onto the substrate W by discharging the imprint material R from a plurality of nozzles N lined up in the dispenser D on the basis of the coordinate information of the coating information RP. Thereby, the droplets of the imprint material R are supplied onto the substrate W in the placement based on the coating information RP. A method of supplying the imprint material R onto the substrate W may be to discharge the imprint material R while moving the dispenser D instead of moving the substrate stage 302, or to move the substrate stage 302 and the dispenser D with respect to each other.

The imprint material R is applied onto the substrate W on the basis of the coating information RP, and then the mold M is brought into contact with the imprint material R supplied to the substrate W (imprinting or patterning), so that the imprint material R is filled into the concave portions within the pattern P of the mold M.

The center surface of the mold chuck 303 opposite to the surface of the pattern P has a concave portion larger than the region of the pattern P, which is sealed by the mold and a sealing glass (not shown). A pressure control unit (not shown) is connected to this sealed space (cavity portion), and the pressure in the sealed space can be controlled. By increasing the pressure in the cavity portion and deforming the mold M into a convex shape during imprinting, air bubbles are prevented from being interposed between the substrate W and the mold M during imprinting. When the imprint material on the substrate W and the mold M come into contact with each other, the pressure in the cavity portion is returned so that the imprint material on the substrate W and the pattern P of the mold M come into complete contact with each other. After contact, the imprint material is cured through irradiation with light having a predetermined wavelength to form a pattern on the imprint material R in a predetermined pattern region of the substrate W. Thereafter, the mold M is separated from the cured imprint material R. Thereby, a three-dimensional pattern (concavo-convex pattern) is formed on the substrate W.

### Example 1

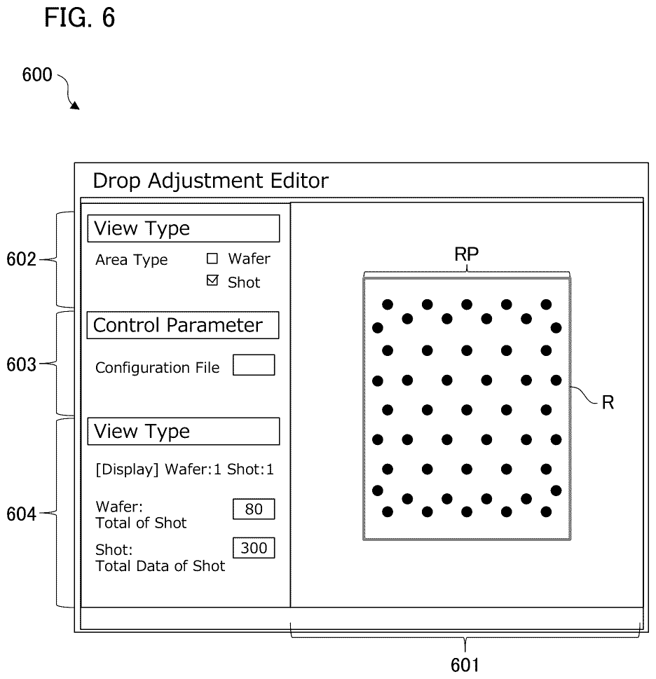

FIG. 6 is a diagram illustrating an example of an operation screen of the editor 600 that functions as a user interface. The editor 600 is used to generate and edit the coating information RP, and is generated by the control unit 220 and provided as a user interface. In the present example, the editor 600 generated by the control unit 220 is managed by the console unit 210 and displayed on the monitor 201. However, the editor 600 may be generated by the control unit 220 included in the imprint apparatus IMP, or may be generated by an information processing apparatus external to the imprint apparatus IMP. Similarly, the editor 600 may be displayed on the monitor 201 included in the imprint apparatus IMP, or may be displayed on a monitor external to the imprint apparatus IMP. Meanwhile, here, an example in which the editor 600 is displayed on the monitor 201 will be described.

In the editor 600, the coating information RP indicating the position and amount of the imprint material R to be supplied onto the substrate W is displayed in an area 601. In addition, it has an area 602 in which parameters can be set to switch the display content of the area 601, for example, between displaying the entire substrate and displaying the shot region. Further, it has an area 603 in which parameters such as a configuration information file (configuration file) for acquiring inspection information after imprinting can be set. In addition, information acquired from the configuration information file is displayed in an area 604.

A program for operating the editor 600 may be provided in the simulation apparatus 200 as described in the present embodiment. Further, it may be provided on a computer (not shown) connected to the outside of the simulation apparatus 200 or the imprint apparatus IMP through a wired or wireless communication line.

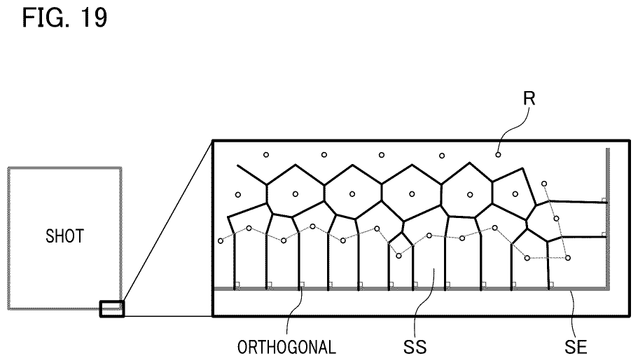

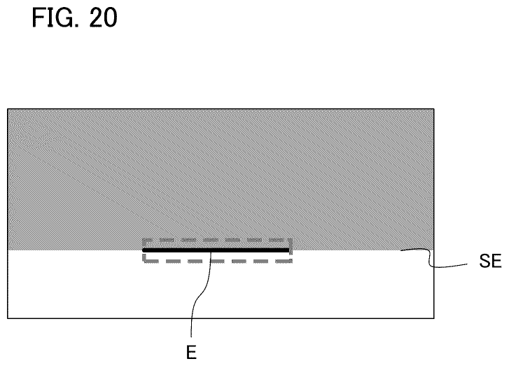

In the editor 600, inspection information (inspection data) is acquired for the entire surface or part of the substrate W after the imprint process, and features (feature amounts) are extracted by performing image analysis. Here, the inspection information is, for example, an image obtained by the image capturing unit CAM, and includes image information of the pattern P formed on the substrate after the imprint process. The acquired inspection information is analyzed to acquire analysis information relating to the result of the imprint process. Here, the analysis information is, for example, defect information relating to a defect in the substrate W after the imprint process. FIGS. 19 and 20 show examples of display of analysis information to be described later. The acquisition of the analysis information is based on the inspection information, and the defect information is acquired by analyzing the type, size, shape, or the like of the defect. In addition, the acquisition of the analysis information may be based on the inspection information, and information indicating the spread of droplets (drops) of the imprint material, that is, information on filling the pattern of the mold M, may be generated as the analysis information. Further, information for correcting (adjusting) the coating information is calculated on the basis of the analysis information obtained by analyzing the acquired inspection information.

In order to correct the coating information RP on the basis of the acquired defect information, defects and drops are associated with each other. If the placement of drops in the periphery of the shot is adjusted, the location of extrusion and nonfill defects will change depending on the placement of the drops. In order to suppress extrusion and nonfill in the periphery of the shot, it is necessary to specify drops causing these defects and adjust their positions. By predicting how a drop will spread, defects and drops are associated with each other. The spread prediction simulation in the present example is performed on the simulation apparatus 200, and the drop spread prediction information itself is displayed or the associated drops are displayed in the editor 600.

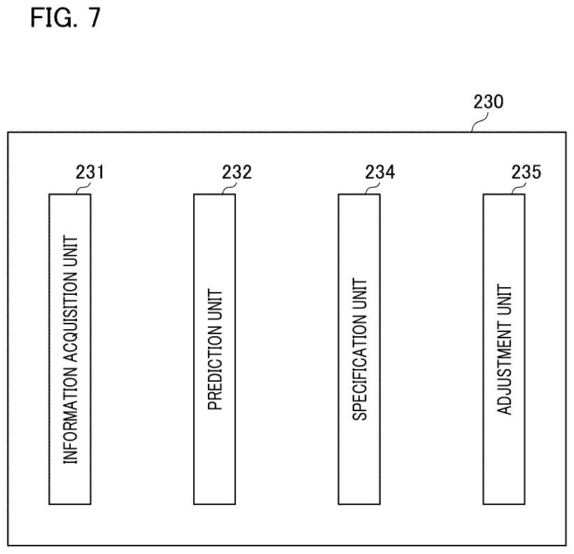

FIG. 7 is a configuration diagram illustrating a configuration example of the simulator 230 in Example 1. The simulator 230 includes an information acquisition unit 231, a prediction unit 232, a specification unit 234, and an adjustment unit 235.

The information acquisition unit 231 acquires the coating information including information on the placement and amount of a plurality of droplets of the imprint material on the substrate W, for example, from the console unit 210. In addition, the information acquisition unit 231 predicts and acquires information indicating a first droplet region which is a region where each of the droplets spreads around the droplet of the imprint material R. The details of the information indicating the first droplet region will be described later.

In the imprint process, around the droplets of the imprint material R located in the boundary region (boundary droplet) which is a region on the substrate corresponding to the edge of the mold M, the prediction unit 232 predicts a region where each of the boundary droplets spreads as a second droplet region. The details of the second droplet region will be described later.

The specification unit 234 specifies the droplets of the imprint material R of which the placement positions need to be adjusted by comparing the spread image of the imprint material R acquired by the image capturing unit CAM with the second droplet region predicted by the prediction unit 232. In addition, the specification unit 234 may specify the droplets of the imprint material R of which the placement positions need to be adjusted by comparing the second droplet region predicted by the prediction unit 232 with the defect information.

The adjustment unit 235 determines the placement adjustment amount and adjustment direction of the droplets of the imprint material R on the substrate W. In other words, the adjustment unit 235 calculates the placement adjustment amount and adjustment direction of the imprint material R for changing the coating information RP.

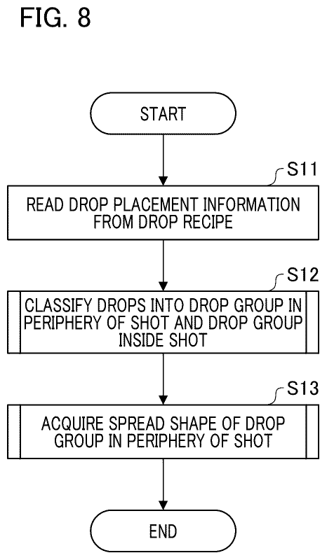

Next, the overall flow of the spread simulation process of the imprint material R in the simulation apparatus 200 according to Example 1 will be described with reference to FIG. 8. FIG. 8 is a flowchart illustrating an example of a simulation process for the spread of drops in the periphery of the shot in Example 1. Each operation (step) shown in this flowchart can be executed under control of the CPU 101 of the simulation apparatus 200.

In step S11, the information acquisition unit 231 reads the droplet of the imprint material R, that is, the coordinate information (drop placement information) of the drop on the substrate W, from the drop recipe.

In step S12, the prediction unit 232 classifies the plurality of drops of the imprint material R placed on the substrate W into a drop group in the periphery of the shot and a drop group inside the shot. Here, the drop group in the periphery of the shot is a group of droplets of the imprint material R located in a boundary region which is a region on the substrate corresponding to the edge of the mold M in the imprint process. In other words, it is a group of droplets of the imprint material R located in the peripheral region of the shot region on the substrate W. In addition, the drop group inside the shot is a group of droplets of the imprint material R placed on the substrate W other than the drop group in the periphery of the shot.

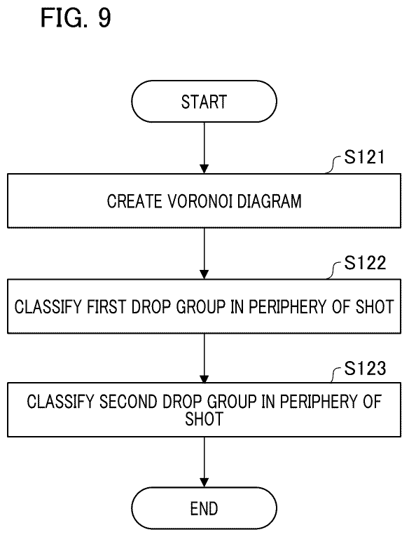

Here, an example of a method of classifying a drop group in the periphery of the shot and a drop group inside the shot will be described with reference to FIG. 9. FIG. 9 is a flowchart illustrating an example of a classification process for drops in step S12 of FIG. 8. Each operation (step) shown in this flowchart can be executed under control of the CPU 101 of the simulation apparatus 200. Meanwhile, the method of classifying a drop group in the periphery of the shot and a drop group inside the shot is not limited to the method described here.

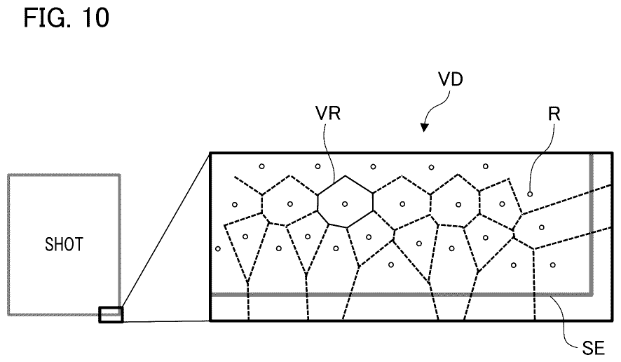

First, in step S121, the information acquisition unit 231 predicts and acquires, for example, a Voronoi diagram (VD) from the drop placement information. The Voronoi diagram VD is information indicating the first droplet region. Specifically, the Voronoi diagram VD of a geometrical shape is used. Here, the Voronoi diagram VD is a diagram in which a plurality of points (base points) placed at any position on a certain metric space are divided into regions according to which base point other points on the same metric space are close to, and here a Voronoi diagram is created with a point as the drop of the imprint material R to perform prediction. Meanwhile, the Voronoi diagram VD created by an external apparatus may be acquired by the information acquisition unit 231. FIG. 10 is a diagram illustrating an example of the Voronoi diagram VD acquired in step S121. In this drawing, a certain region at the lower right of the shot region is enlarged to display the drop of the imprint material R. The Voronoi diagram VD shows a Voronoi region VR (first droplet region) which is a region where each drop spreads around the drop of the imprint material R. The Voronoi region VR can be said to be a predicted region in which each drop spreads around the drop of the imprint material R. That is, the information acquisition unit 231 predicts and acquires the first droplet region on the basis of the placement of droplets of a plurality of imprint materials on the substrate W.

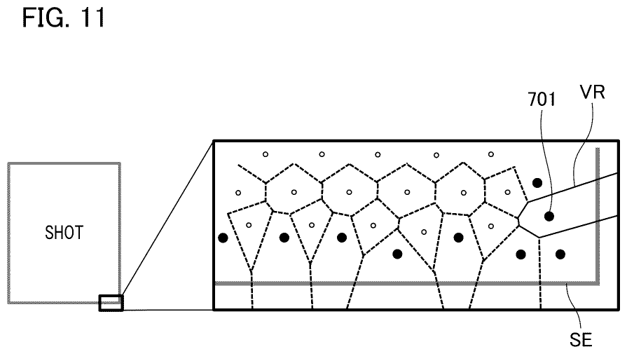

Next, in step S122, the prediction unit 232 classifies a first drop group 701 in the periphery of the shot. Specifically, the prediction unit 232 determines whether the Voronoi region VR of each drop of the imprint material R is in contact with a shot edge SE. Here, the shot edge SE is the edge of the shot region. FIG. 11 is a diagram illustrating the process of step S122. If the Voronoi region VR is in contact with the shot edge SE, the prediction unit 232 extracts the drop of the imprint material R which is its base point as the first drop group 701 in the periphery of the shot. In this drawing, the drops indicated by black circles are the first drop group 701 in the periphery of the shot.

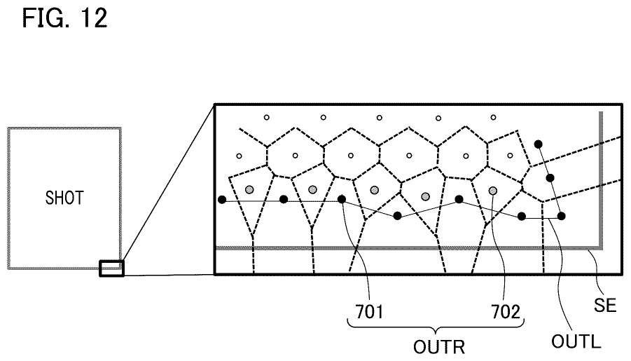

Next, in step S123, the prediction unit 232 classifies a second drop group 702 in the periphery of the shot. Specifically, the prediction unit 232 draws a line segment OUTL (line) between drops adjacent to each other in a direction parallel to the shot edge SE of the first drop group 701 in the periphery of the shot extracted in step S122. The prediction unit 232 then determines whether the Voronoi region VR with drops other than the first drop group 701 in the periphery of the shot as base points is in contact with the generated line segment OUTL. If the region is in contact, the drops are extracted as the second drop group 702 in the periphery of the shot. FIG. 12 is a diagram illustrating the process of step S123. In this drawing, the drops indicated by gray circles are the second drop group 702 in the periphery of the shot. The first drop group 701 in the periphery of the shot and the second drop group 702 in the periphery of the shot are collectively referred to as an OUTR drop group in the periphery of the shot, and the others are the drop group inside the shot.

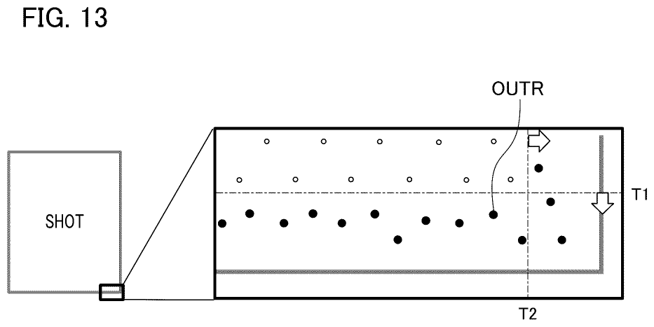

Next, another example of the method of classifying a drop group in the periphery of the shot and a drop group inside the shot will be described with reference to FIG. 13. FIG. 13 is a diagram illustrating an example of a classification process for drops. In FIG. 13, drops are simply classified into a drop group in the periphery of the shot and a drop group inside the shot on the basis of a threshold T. For example, the lower portion of the shot region may be classified as a threshold T1, and the right portion of the shot region may be classified as the drop group OUTR in the periphery of the shot for drops outside a threshold T2 and as the drop group inside the shot for the inner portion. Instead of classifying the entirety of one side of the shot region using one threshold, the threshold may be changed depending on the location of one side. In addition, drops may be manually classified into a drop group in the periphery of the shot and a drop group inside the shot. In addition, only the drops where the Voronoi region VR rests across (is in contact with) the shot edge SE may be defined as the drop group in the periphery of the shot.

The spread shape of drops for the drop group OUTR in the periphery of the shot and the drop group inside the shot which are thus obtained are predicted to have different spread shapes on the simulation apparatus 200, and predicted shape information of the drop spread is displayed on the editor 600.

Referring back to FIG. 8, next, a specific method of acquiring the spread shape of drops in the periphery of the shot in step S13 will be described. In step S13, the prediction unit 232 predicts the spread shape of drops in a Voronoi diagram for the drop group inside the shot. On the other hand, the prediction unit 232 can predict the spread shape of drops with a higher degree of accuracy by predicting the drop group OUTR in the periphery of the shot in a way other than the Voronoi diagram. That is, the prediction unit 232 predicts the region (second droplet region) in which each of the drops in the drop group OUTR in the periphery of the shot will spread in a different way from the region (first droplet region) in which each of the drops spreads around the drop of the drop group inside the shot.

Here, the reason why the drop inside the shot spreads according to the Voronoi diagram, that is, into the Voronoi region VR, and the drop in the periphery of the shot does not spread according to the Voronoi diagram will be described. Since drops exist in the periphery of the drop inside the shot and are surrounded, a case does not occur in which the drop will collapse the Voronoi diagram and spread due to being blocked by the surrounding drops. However, even if the drops in the periphery of the shot are surrounded by drops, the force preventing the drops from spreading is weaker than the force attempting to spread them, and thus the Voronoi diagram will collapse. Thus, the periphery of the shot does not spread according to the Voronoi diagram.

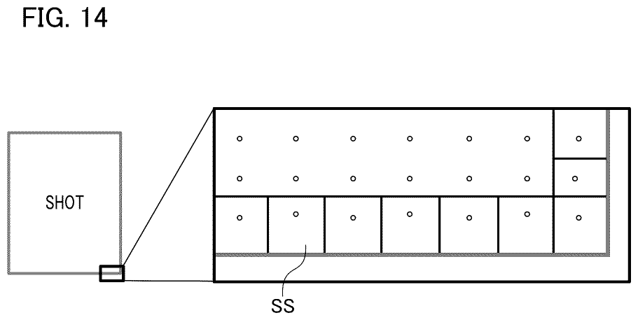

FIG. 14 is a diagram illustrating a first example in which the spread shape SS of drops in the periphery of the shot is predicted using a method different from the Voronoi diagram. This drawing is a diagram in which the spread shape SS of the drop group OUTR in the periphery of the shot, that is, the second droplet region, is predicted to have a simple rectangular. In the case of a drop located at the lower end of the shot region as shown in FIG. 14, a rectangle is drawn with the upper limit being the midpoint between the drops inside the shot adjacent to each other, and the right and left ends being the midpoints between the drops in the periphery of the shot adjacent to each other. That is, the prediction unit 232 predicts the spread shape SS of the drop group OUTR in the periphery of the shot by drawing a rectangle so as to spread in the direction of the shot edge SE from the midpoint of the drops in the periphery of the shot adjacent to each other. If the drops in the periphery of the shot are placed in a rectangular lattice shape on the substrate W, it is effective to predict the spread shape of drops in the periphery of the shot with a simple rectangle as shown in this drawing, and the time required for the prediction process can also be shortened.

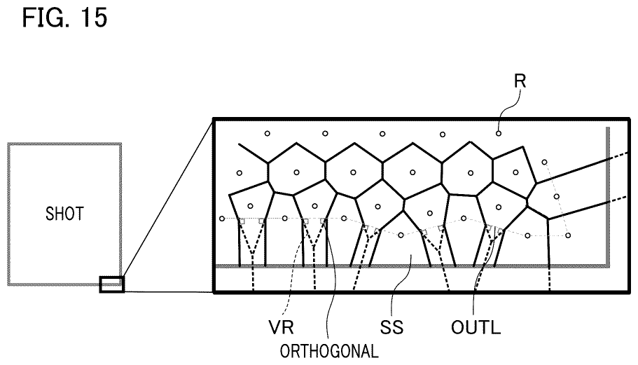

FIG. 15 is a diagram illustrating a second example in which the spread shape SS of drops in the periphery of the shot is predicted using a method different from the Voronoi diagram. In FIG. 15, the point of intersection of the Voronoi region VR of an arbitrary drop in the periphery of the shot and the line segment OUTL connecting the arbitrary drop in the periphery of the shot and two drops adjacent to each other is calculated. A region in which the line is extended from the point of intersection in a direction orthogonal to the line segment OUTL and toward the shot edge is used as the spread shape SS. This makes it possible to predict the spread shape SS of drops in the periphery of the shot with a higher degree of accuracy. The drops in the periphery of the shot that do not touch the shot edge SE in the Voronoi diagram shown in FIG. 12, that is, the second drop group 702 in the periphery of the shot, also collapses the Voronoi region VR due to the force of spreading and does not spread according to the Voronoi diagram. However, according to the method shown in FIG. 15, the spread shape of drops can also be predicted with a higher degree of accuracy for such a second drop group 702 in the periphery of the shot.

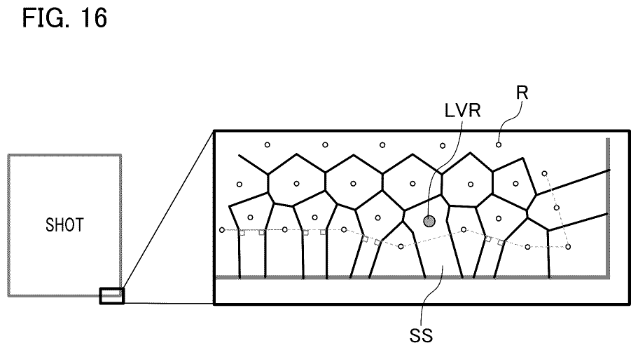

FIG. 16 is a diagram illustrating a third example in which the spread shape SS of drops in the periphery of the shot is predicted using a method different from the Voronoi diagram. The prediction unit 232 predicts the second droplet region in accordance with the amount of droplets of the imprint material R. Specifically, FIG. 16 shows a diagram when a drop large volume resist (LVR) of which the amount of drops is larger than a threshold is set in the coating information RP. The prediction unit 232 predicts that the spread of the drop LVR of which the amount of drops is larger than the threshold will be larger than in the case of FIG. 15. In other words, the prediction unit 232 predicts the second droplet region of the drop LVR of which the amount of drops is larger than the threshold to be larger than the drop of which the amount of drops is less than the threshold. This makes it possible to predict the spread shape of drops in the periphery of the shot with a higher degree of accuracy in accordance with the amount of the imprint material included in the drop.

As described above, according to the present example, it is possible to predict the spread of drops in the periphery of the shot at high speed and with a high degree of accuracy.

### Example 2

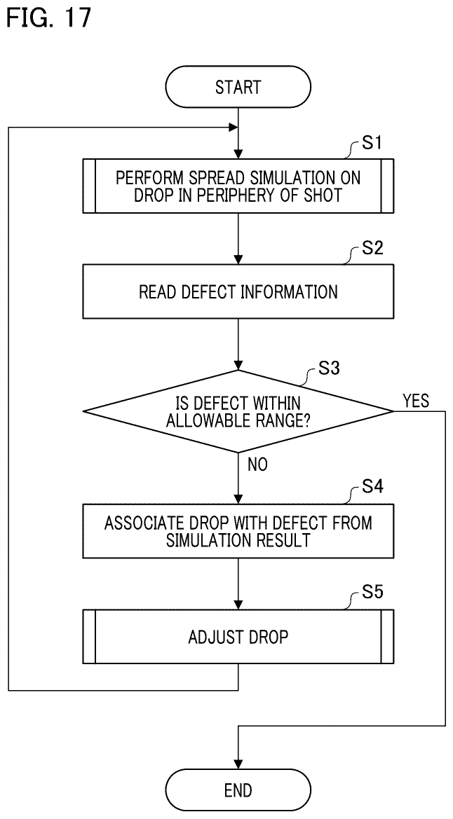

Next, an example in which the drop is adjusted using the predicted shape of the spread of drops in the periphery of the shot (second droplet region) will be shown. Specifically, in the present example, in addition to Example 1, the drop is adjusted using the predicted shape of the spread of drops in the periphery of the shot as shown in the flowchart of FIG. 17. FIG. 17 is a flowchart illustrating an example of a process of adjusting drops according to Example 2. Each operation (step) shown in this flowchart can be executed under control of the CPU 101 of the simulation apparatus 200.

In step S1, the prediction unit 232 performs a drop spread prediction simulation process (a process shown in FIG. 8) in the periphery of the shot in Example 1.

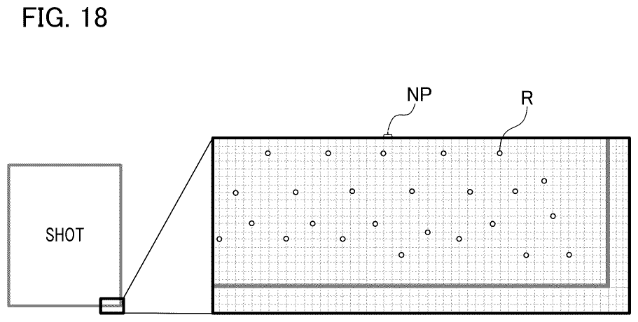

Here, an example in which the spread of drops in the periphery of the shot is predicted on the premise of adjustment of the drops will be shown. As described above, in the imprint apparatus IMP, the head used to coat the droplets of the imprint material R onto the substrate is referred to as the dispenser D. Due to the structure of the dispenser D, there are restrictions on the positions of drops that can be placed. FIG. 18 is a diagram illustrating the positions of drops that can be placed by the dispenser D. Since the nozzle pitch NP of the dispenser D is fixed, the imprint material R cannot be discharged between the nozzles, for example, as shown by the broken line lattice in FIG. 18. By controlling the dispenser D in a reciprocating manner, it is also possible to discharge the material on the return path to a place where the material cannot be discharged on the outward path. However, an increase in the number of reciprocations results in a decrease in throughput and an increase in the time required to start the imprint process, which leads to a problem of resist droplets discharged previously being volatilized. Thus, when the placement position of the drop is adjusted, it is preferable to adjust the placement of the drop in accordance with the constraint. FIG. 19 is a diagram illustrating an example in which the spread shape SS of drops in the periphery of the shot according to Example 2 is predicted. FIG. 19 shows a prediction of the spread shape SS of drops in the periphery of the shot in a case where the minimum unit of movement of the drop can only be moved at a defined pitch in the vertical and horizontal directions depending on the nozzle pitch NP as an example of the constraint on the placement position of the drop. The prediction unit 232 predicts the spread shape SS of the drop group in the periphery of the shot to be perpendicular to the shot edge SE. This makes it possible to facilitate the adjustment of the placement position of the drop even if there are constraints on the positions of drops that can be placed due to the structure of the dispenser D.

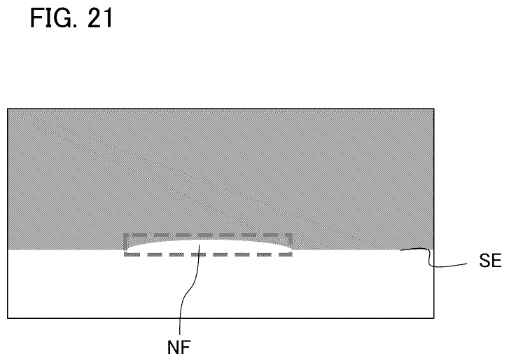

Referring back to FIG. 17, next, in step S2, defect information is read. Here, the defect information may be determined by a person, that is, manually detected, or may be automatically detected by a apparatus that performs defect inspection. In addition, the defect information includes the size of a defect, coordinate information, and defect classification information (type information). Here, defects that occur in the imprint process will be described with reference to FIGS. 20 and 21. Defects include nonfill that occurs when the imprint material R is not filled between the mold M and the substrate W, extrusion that occurs when the imprint material R protrudes from the shot region, and the like. For example, if nonfill occurs, the process will not function in the first place, and if extrusion occurs, the mold M will be damaged during the imprint process on the adjacent shot region, both of which will cause adverse effects in the subsequent processes. FIG. 20 is a diagram illustrating an example of analysis information on extrusion E. FIG. 20 is an example of an image acquired by the image capturing unit CAM, and the extrusion E is indicated by the black thick line in the region surrounded by the broken line on the shot edge SE. Here, the region surrounded by the broken line is rectangular and specified to be larger than the region of the extrusion E, but the region may be used as the analysis information, or the extrusion E itself may be used as the analysis information. FIG. 21 is a diagram illustrating an example of analysis information on nonfill NF. In FIG. 21, the while region surrounded by the broken line is nonfill which is not filled. Here, similarly, the region surrounded by the broken line is rectangular and specified to be larger than the region of the nonfill NF, but the region may be used as the analysis information, or the nonfill NF itself may be used as the analysis information.

Referring back to FIG. 17, next, in step S3, the prediction unit 232 determines whether the defect is within an allowable range. Meanwhile, here, it is preferable that there is no defect. Here, if the defect is within the allowable range (Yes), the process ends. On the other hand, here, if the defect is not within the allowable range (No), the process proceeds to step S4.

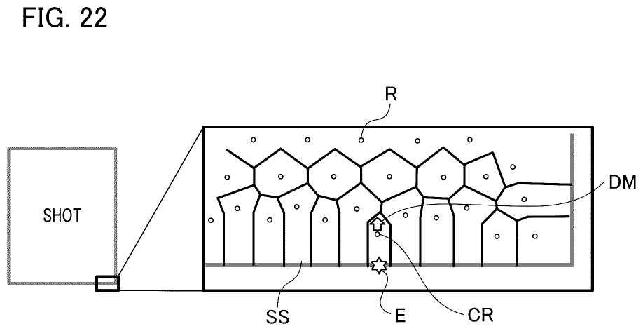

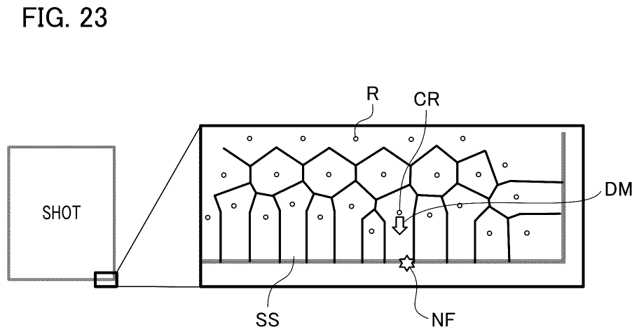

Next, in step S4, the specification unit 234 associates drops with defects from the simulation result. FIG. 22 is a diagram illustrating an example of a process of associating drops with the extrusion E in step S4. This drawing shows the spread shape SS of drops of the imprint material R and the extrusion E in the periphery of the shot. The specification unit 234 determines (specifies) a corresponding drop CR (corresponding resist) of a drop corresponding to the region of the spread shape SS in which the extrusion E exists. In other words, the specification unit 234 sets the droplet of the imprint material in which the extrusion E exists within the second droplet region as the corresponding drop CR. FIG. 23 is a diagram illustrating an example of a process of associating drops with the nonfill NF in step S4. This drawing shows the spread shape SS of drops of the imprint material R and the nonfill NF in the periphery of the shot. The specification unit 234 sets the drop corresponding to the region of the spread shape SS in which the nonfill NF exists as the corresponding drop CR. In other words, the specification unit 234 sets the droplet of the imprint material in which the nonfill NF exists within the second droplet region as the corresponding drop CR.

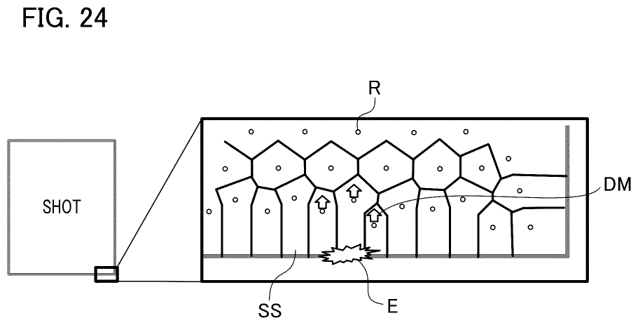

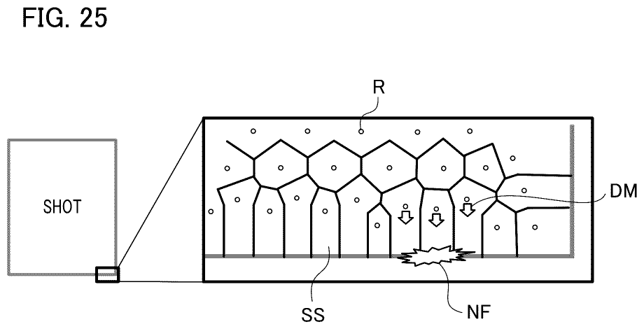

Next, in step S5, the adjustment unit 235 adjusts the drop. Specifically, the adjustment unit 235 calculates the direction of movement and the amount of movement of the drop for adjusting the drop. FIGS. 22 and 23 show the direction of movement DM for adjusting the drop. Here, it is assumed that the drop position is moved at a defined pitch in the vertical and horizontal directions which is the minimum unit dependent on the nozzle pitch NP. The adjustment unit 235 determines the direction in which the drop is moved in accordance with the type of defect detected. Specifically, in the case of the extrusion E as shown in FIG. 24, the drop is moved so as to be away from the extrusion E. In the case of the nonfill NF as shown in FIG. 25, the drop is moved so as to be closer to the nonfill NF.

Processing in a case where a defect is large and straddles the spread shape SS of a plurality of drops will be described with reference to FIGS. 24 and 25. FIGS. 24 and 25 are diagrams illustrating an example in which a defect straddles the spread shape SS of a plurality of drops. If a plurality of drops are associated with one and the same defect, the defect may be eliminated without adjusting the positions of all the drops. Thus, the adjustment unit 235 may determine not to move some of the drops among the plurality of drops associated with one and the same defect, depending on the ratio of defects in the spread shape SS.

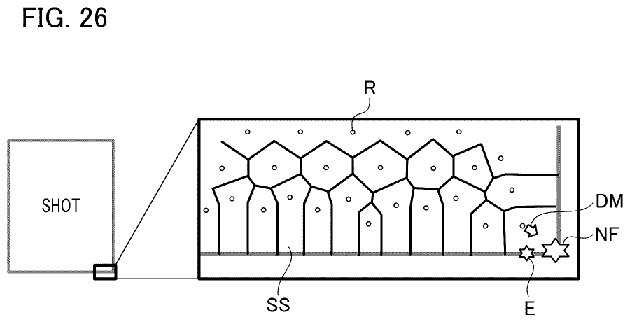

Processing in a case where different types of defects exist in the spread shape SS of the same drop will be described with reference to FIG. 26. FIG. 26 is a diagram illustrating an example in which different types of defects exist in the spread shape SS of the same drop. In such a case, the adjustment unit 235 compares the extrusion E with the size of the nonfill NF, and adjusts the drop position so as to correct a larger defect. In the case shown in this drawing, the nonfill NF is larger than the extrusion E, and thus the drop is moved so as to be closer to the nonfill NF. Alternatively, a setting may be made in which defects near the corners are preferentially adjusted, or conversely, defects far from the corners are preferentially corrected.

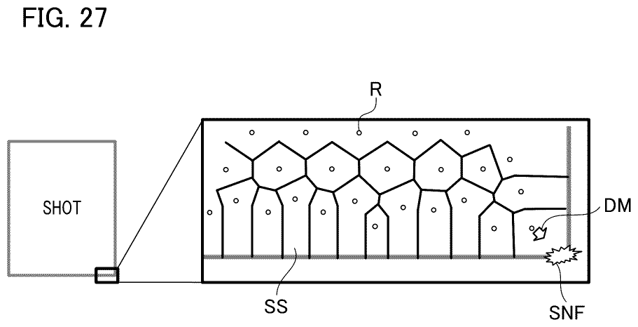

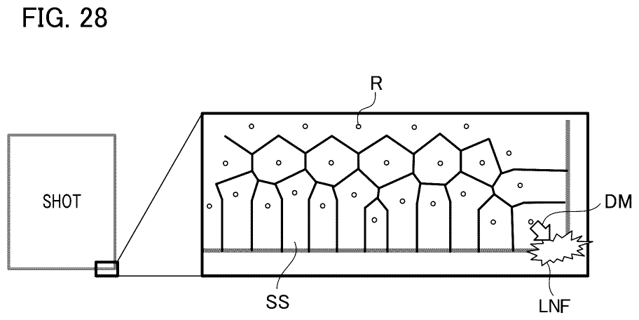

An example in which the amount of movement of drops is changed in accordance with the size of a defect will be described with reference to FIGS. 27 and 28. FIGS. 27 and 28 are diagrams illustrating an example in which the amount of movement of drops is changed in accordance with the size of a defect. FIG. 27 shows a relatively small nonfill SNF, and thus the drop is moved to be small in accordance with the size of a defect. FIG. 28 shows a relatively large nonfill LNF, and thus the drop is moved to be large in accordance with the size of a defect. That is, the adjustment unit 235 determines the amount of movement of the drop in accordance with the size of a defect. Specifically, for example, a table of the amount of movement according to the size of a defect may be prepared, and the amount of movement may be determined on the basis of the table. Through such processing, the amount of movement of drops can be changed depending on the size of a defect.

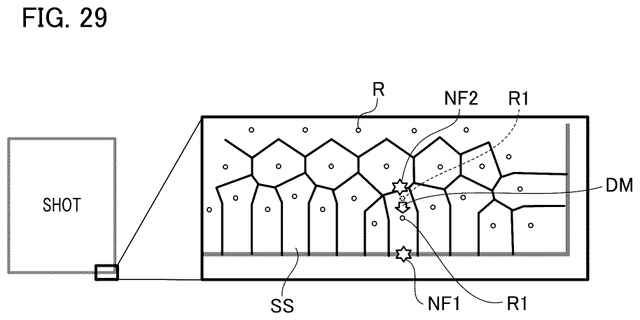

Further, processing in a case where another defect occurs after the adjustment of a drop will be described with reference to FIG. 29. FIG. 29 is a diagram illustrating processing in a case where another defect occurs after the adjustment of a drop. This drawing shows an example in which a drop R1 to be adjusted is moved in the direction of the shot edge SE because of the existence of nonfill NF1, and then nonfill NF2 which is a new defect occurs in a direction opposite to the shot edge SE. In such a case, a minimum unit amount of imprint material is added to the drop R1 to be adjusted. That is, the adjustment unit 235 calculates the amount of adjustment of the total amount of the drop R1 to be adjusted if a new defect occurs after placement of the drop is adjusted. The drop recipe is then changed to increase the amount of the imprint material of the drop R1 to be adjusted. If defects of nonfill still occur, it is possible to adjust the drop without causing defects, for example, by changing the drop recipe so as to add the amount of a minimum unit plus one unit of imprint material to the drop R1 to be adjusted.

Meanwhile, such defect information and the adjustment direction and adjustment amount of the drop for the defect may be stored in, for example, a storage unit (not shown) in association with each other, and the adjustment unit 235 may use the stored information to determine the adjustment direction and adjustment amount of the drop. This makes it possible to adjust the drop in order to reduce the occurrence of defects with a higher degree of accuracy and at high speed.

Referring back to FIG. 17, after the adjustment of the drop in step S5 is completed, steps S1 to S3 are repeated again until the defect falls within the allowable range. If the defect falls within the allowable range in step S3, the process ends.

Meanwhile, after the adjustment of the drop in step S5 is completed, the adjusted drop recipe may be displayed on the monitor 201 through the console unit 210. This makes it possible for a user to confirm the adjusted drop recipe.

As described above, according to the present example, by predicting the spread of drops in the periphery of the shot at high speed and with a high degree of accuracy, it is possible to facilitate the adjustment of the drops and to reduce the occurrence of defects.

### Embodiment of Article Manufacturing Method

The pattern of a cured product formed by the imprint apparatus performing the imprint process using the simulation results of the simulation apparatus 200 is used permanently on at least a portion of various articles, or temporarily when various articles are manufactured. Examples of the article include an electric circuit element, an optical element, an MEMS, a recording element, a sensor, a mold, and the like. Examples of electric circuit elements include volatile or non-volatile semiconductor memories such as a DRAM, an SRAM, a flash memory, or an MRAM, semiconductor elements such as an LSI, a CCD, an image sensor, or an FPGA, and the like. Examples of the mold include a mold for imprinting and the like.

The pattern of the cured product is used at it is as a configuration member of at least a portion of the above articles, or is used temporarily as a resist mask. After etching, ion implantation, or the like is performed in a substrate processing step, the resist mask is removed.

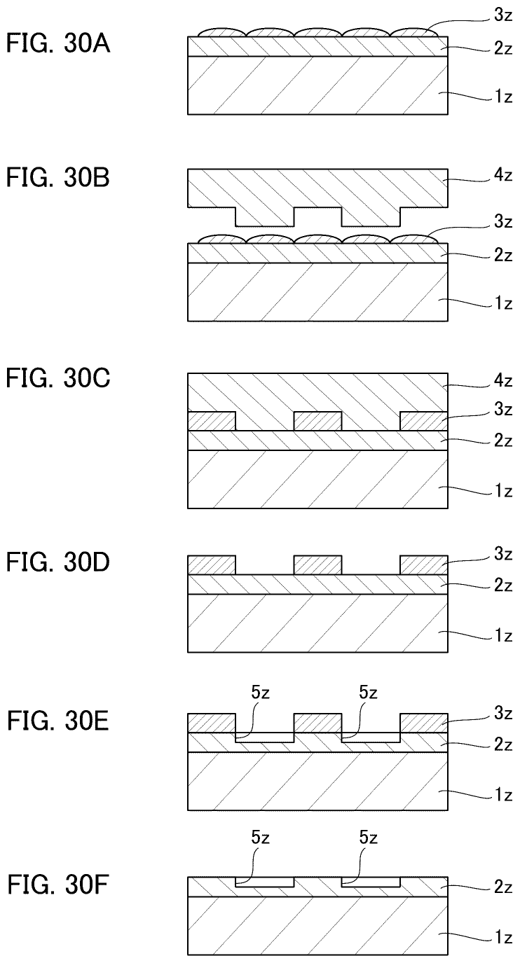

Next, a specific method of manufacturing an article will be described. As shown in FIG. 30 (A), a substrate 1z such as a silicon wafer having a workpiece 2z such as an insulator formed on its surface is prepared, and then a composition 3z is applied to the surface of the workpiece 2z using an inkjet method or the like. Here, a state in which the composition 3z in the form of a plurality of droplets is applied onto a substrate is shown.

As shown in FIG. 30 (B), a mold 4z for imprinting is placed so that the side on which its concavo-convex pattern is formed faces the composition 3z on the substrate. As shown in FIG. 30(C), the substrate 1z to which the composition 3z is applied and the mold 4z are brought into contact with each other, and pressure is applied. The composition 3z is filled into a gap between the mold 4z and the workpiece 2z. In this state, if light is radiated as energy for curing through the mold 4z, the composition 3z is cured.

As shown in FIG. 30(D), if the composition 3z is cured and then the mold 4z and the substrate 1z are separated from each other, a pattern of the cured product of the composition 3z is formed on the substrate 1z. This pattern of the cured product has a shape in which the concave portions of the mold correspond to the convex portions of the cured product, and the convex portions of the mold correspond to the concave portions of the cured product, that is, the concavo-convex pattern of the mold 4z is transferred to the composition 3z.

As shown in FIG. 30(E), if etching is performed using the pattern of the cured product as an etching-resistant mask, a portion of surface of the workpiece 2z where there is no or thin cured product is removed to form grooves 5z. As shown in FIG. 30(F), if the pattern of the cured product is removed, it is possible to obtain an article in which the grooves 5z are formed on the surface of the workpiece 2z. Although the pattern of the cured product is removed here, it may be used, for example, as a film for interlayer insulation included in a semiconductor element or the like, that is, as a configuration member of an article without removal after processing. Meanwhile, although an example in which a mold for circuit pattern transfer provided with a concavo-convex pattern is used as the mold 4z has been described, a mold having a flat portion without a concavo-convex pattern (flat template) may be used.

### Other Embodiments

Hereinbefore, although the preferable embodiments of the present invention have been described, the present invention is not limited to these embodiments, and various modifications and changes are possible without departing from the scope of the gist.

The present invention can also be realized by a process in which a program for realizing one or more functions of the above-described embodiments is supplied to a system or apparatus through a network or a storage medium and one or more processors in a computer of the system or apparatus read out and execute the program. In addition, the present invention can also be realized by a circuit (for example, an ASIC) that realizes one or more functions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-069979, Apr. 21, 2023, which is hereby incorporated by reference wherein in its entirety.

What is claimed is:

1. A simulation apparatus configured to, in a process of bringing a member into contact with a plurality of droplets placed on a substrate to form a film of a curable composition on the substrate, predict spread of boundary droplets located in a boundary region which is a region on the substrate corresponding to at least an edge of the member when the member is contacted, the simulation apparatus comprising:
an acquisition unit configured to acquire information indicating placement of the plurality of droplets on the substrate and a first droplet region which is a predicted region in which each of the droplets spreads around the droplet; and
a prediction unit configured to predict, as a second droplet region, a region in which each of the boundary droplets spreads around the boundary droplet in a different way from the first droplet region of droplets other than the boundary droplet in the first droplet region acquired by the acquisition unit.

2. The simulation apparatus according to claim 1, wherein the acquisition unit predicts and acquires the first droplet region on the basis of the placement of the plurality of droplets on the substrate.

3. The simulation apparatus according to claim 2, wherein the acquisition unit predicts the first droplet region using a Voronoi diagram with the droplet as a base point.

4. The simulation apparatus according to claim 1, wherein the prediction unit specifies the boundary droplet and predicts the second droplet region on the basis of an information indicating the first droplet region acquired by the acquisition unit.

5. The simulation apparatus according to claim 1, wherein the prediction unit specifies, as the boundary droplets, first droplets in which the first droplet region is in contact with an edge of a formation region on the substrate among the plurality of droplets and second droplets in which the first droplet region is in contact with a line segment connecting the first droplets adjacent to each other.

6. The simulation apparatus according to claim 5, wherein the prediction unit predicts the second droplet region so as to spread from a point of intersection of a line segment connecting the first droplets adjacent to each other and a boundary line of the first droplet region in a direction orthogonal to the line segment and toward the edge of the formation region.

7. The simulation apparatus according to claim 1, wherein the prediction unit predicts the second droplet region so as to spread from a midpoint of the boundary droplets adjacent to each other toward an edge of a formation region on the substrate.

8. The simulation apparatus according to claim 1, wherein the prediction unit predicts the second droplet region in accordance with an amount of droplets of the curable composition.

9. The simulation apparatus according to claim 1, further comprising:
an image acquisition unit configured to acquire a spread image of the droplet when the member is brought into contact with the droplet placed on the substrate; and
a specification unit configured to specify the droplet whose placement position needs to be adjusted by comparing the spread image acquired by the image acquisition unit with the second droplet region predicted by the prediction unit.

10. The simulation apparatus according to claim 1, further comprising a specification unit configured to specify the droplet whose placement position needs to be adjusted by comparing the second droplet region predicted by the prediction unit with defect information in the film of the curable composition,
wherein the defect information includes information on manual or automatic detection of a defect in the film of the curable composition.

11. The simulation apparatus according to claim 1, further comprising an adjustment unit configured to adjust the placement of the droplets,
wherein the adjustment unit determines a direction in which the droplets are moved in accordance with the type of defect in the film of the curable composition.

12. The simulation apparatus according to claim 1, further comprising an adjustment unit configured to adjust the placement of the droplets,
wherein the adjustment unit determines an amount by which the droplets are moved in accordance with the size of a defect in the film of the curable composition.

13. The simulation apparatus according to claim 1, further comprising an adjustment unit configured to adjust the placement of the droplets,
wherein the adjustment unit calculates an amount of adjustment of a total amount of the droplets if a new defect occurs after placement of the droplets is adjusted.

14. The simulation apparatus according to claim 1, further comprising an adjustment unit configured to adjust the placement of the droplets; and
a display control unit configured to cause a display apparatus to display a drop recipe after the placement adjustment is performed.

15. A simulation method of, in a process of bringing a member into contact with a plurality of droplets placed on a substrate to form a film of a curable composition on the substrate, predicting spread of boundary droplets located in a boundary region which is a region on the substrate corresponding to at least an edge of the member when the member is contacted, the simulation method comprising:
acquiring information indicating placement of the plurality of droplets on the substrate and a first droplet region which is a predicted region in which each of the droplets spreads around the droplet; and
predicting, as a second droplet region, a region in which each of the boundary droplets spreads around the boundary droplet in a different way from the first droplet region of droplets other than the boundary droplet in the acquired first droplet region.

16. A computer-readable storage having a program stored therein, the program causing a computer to execute a simulation method of, in a process of bringing a member into contact with a plurality of droplets placed on a substrate to form a film of a curable composition on the substrate, predicting spread of boundary droplets located in a boundary region which is a region on the substrate corresponding to at least an edge of the member when the member is contacted, the simulation method comprising:
acquiring information indicating placement of the plurality of droplets on the substrate and a first droplet region which is a predicted region in which each of the droplets spreads around the droplet; and
predicting, as a second droplet region, a region in which each of the boundary droplets spreads around the boundary droplet in a different way from the first droplet region of droplets other than the boundary droplet in the acquired first droplet region.

17. A method of manufacturing an article, the method comprising:
forming a pattern on a substrate using a prediction result of a simulation apparatus; and
processing the substrate on which the pattern is formed in the forming,
wherein the simulation apparatus is configured to, in a process of bringing a member into contact with a plurality of droplets placed on the substrate to form a film of a curable composition on the substrate, predict spread of boundary droplets located in a boundary region which is a region on the substrate corresponding to at least an edge of the member when the member is contacted, the simulation apparatus including
an acquisition unit configured to acquire information indicating placement of the plurality of droplets on the substrate and a first droplet region which is a predicted region in which each of the droplets spreads around the droplet, and
a prediction unit configured to predict, as a second droplet region, a region in which each of the boundary droplets spreads around the boundary droplet in a different way from the first droplet region of droplets other than the boundary droplet in the first droplet region acquired by the acquisition unit, and
an article is manufactured from the substrate processed in the processing.
